(19) United States
(12) Patent Application Publication
(10) Pub. No.: US 2026/0269448 A1
(43) Pub. Date: Sep. 10, 2026

(54) Wireless Communications Circuitry having a Hybrid Coupler with Increased Coupling

(71) Applicant: Apple Inc., Cupertino, CA (US)

(72) Inventors: Haowei Jiang, San Diego, CA (US); Song Hu, San Jose, CA (US); Ming-Da Tsai, San Jose, CA (US); Xiang Guan, Saratoga, CA (US)

(21) Appl. No.: 19/071,539

(22) Filed: Mar. 5, 2025

(51) Int. Cl. H01P 5/22; H03F 3/24; H04B 1/40

(52) U.S. Cl. CPC H01P 5/227

(57) ABSTRACT

Wireless communications circuitry that includes a quadrature hybrid coupler is provided. The hybrid coupler can include a first port configured to receive an input signal, a second port configured to output a signal that is in phase with the input signal, a third port configured to output a signal that is 90 degrees out of phase with the input signal, a fourth port that is isolated from at least the first port, a first conductive line coupled between the first port and the second port, and a second conductive line magnetically coupled to the first conductive line and coupled between the third port and the fourth port. The first and second conductive lines can include winding segments disposed in three consecutive conductive routing layers in an interconnect stack. The first conductive line can be magnetically coupled to the second conductive line via a coupling coefficient greater than 0.707.

### FIELD

This disclosure relates generally to electronic devices and, more particularly, to electronic devices with wireless communications circuitry.

### BACKGROUND

Electronic devices can be provided with wireless communications capabilities. An electronic device with wireless communications capabilities has wireless communications circuitry with one or more antennas. A transceiver in the wireless communications circuitry uses the antennas to transmit and receive radio-frequency signals. It can be challenging to design satisfactory wireless communications circuitry for an electronic device.

### SUMMARY

An aspect of the disclosure provides a quadrature hybrid coupling circuit that includes: a first port configured to receive an input signal; a second port configured to output a corresponding signal that is in phase with the input signal; a third port configured to output a corresponding signal that is 90 degrees out of phase with the input signal; a fourth port that is isolated from at least the first port; a first segment of a first conductive line, where the first segment of the first conductive line has a first distal end coupled to the first port; and a first segment of a second conductive line magnetically coupled to the first conductive line, where the first segment of the second conductive line has a first distal end coupled to the third port, where the first segment of the first conductive line and the first segment of the second conductive line are disposed in a first conductive routing layer of an interconnect stack.

The quadrature hybrid coupling circuit can further include: a second segment of the first conductive line, where the second segment of the first conductive line has a first distal end coupled to a second distal end of the first segment of the first conductive line through a first conductive via; and a second segment of the second conductive line, where the second segment of the second conductive line has a first distal end and a second distal end that is coupled to the fourth port, and where the second segment of the first conductive line and the second segment of the second conductive line are disposed in a second conductive routing layer of the interconnect stack.

The quadrature hybrid coupling circuit can further include: a third segment of the first conductive line, where the third segment of the first conductive line has a first distal end coupled to a second distal end of the second segment of the first conductive line through a second conductive via and has a second distal end coupled to the second port; and a third segment of the second conductive line, where the third segment of the second conductive line has a first distal end coupled to the second distal end of the first segment of the second conductive line through third and fourth conductive vias and has a second distal end coupled to the first distal end of the second segment of the second conductive line through a fifth conductive via, and where the third segment of the first conductive line and the third segment of the second conductive line are disposed in a third conductive routing layer of the interconnect stack.

An aspect of the disclosure provides a quadrature hybrid coupler that includes: a first conductive line coupled between a first port and a second port; and a second conductive line magnetically coupled to the first conductive line and coupled between a third port and a fourth port, where a first segment of the second conductive line is disposed in a first conductive routing layer of an interconnect stack and where a first segment of the first conductive line is disposed in the first conductive routing layer and surrounds the first segment of the second conductive line from at least three sides. A second segment of the first conductive line can be disposed in a second conductive routing layer of the interconnect stack, whereas a second segment of the second conductive line can be disposed in the second conductive routing layer and surrounds the second segment of the first conductive line from four sides. A third segment of the second conductive line can be disposed in a third conductive routing layer of the interconnect stack, whereas a third segment of the first conductive line can be disposed in the third conductive routing layer and surrounds the third segment of the second conductive line from at least three sides.

An aspect of the disclosure provides a hybrid coupler that includes: a first conductive line coupled between a first port and a second port; and a second conductive line magnetically coupled to the first conductive line and coupled between a third port and a fourth port, where the first conductive line is magnetically coupled to the second conductive line via a coupling coefficient greater than half of square root of two. The first port can be configured to receive a radio-frequency signal having a wavelength, and the first and second conductive lines can each have a length that is less than a quarter of the wavelength of the radio-frequency signal.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry having transmit and receive circuitry in accordance with some embodiments.

FIG. 3 is a diagram of an illustrative hybrid coupler having a pair of coupled lines in accordance with some embodiments.

FIG. 4 is a side view of an illustrative interconnect stack in which a hybrid coupler can be formed in accordance with some embodiments.

FIG. 5 is a top (plan) view showing a first portion of the hybrid coupler disposed in a first conductive routing layer of the interconnect stack in accordance with some embodiments.

FIG. 6 is a top (plan) view showing a second portion of the hybrid coupler disposed in a second conductive routing layer of the interconnect stack in accordance with some embodiments.

FIG. 7 is a top (plan) view showing a third portion of the hybrid coupler disposed in a third conductive routing layer of the interconnect stack in accordance with some embodiments.

FIG. 8 is a side view showing illustrative broadside coupling and edge coupling in the hybrid coupler in accordance with some embodiments.

FIG. 9 is plot showing gain as a function of wavelength for a hybrid coupler having coupled lines with lengths equal to a quarter wavelength.

FIG. 10 is plot showing gain as a function of wavelength for an illustrative hybrid coupler having coupled lines with lengths less than a quarter wavelength in accordance with some embodiments.

FIG. 11 is a side view showing a portion of an illustrative hybrid coupler with at least three routing lines in four or more conductive routing layers in accordance with some embodiments.

### DETAILED DESCRIPTION

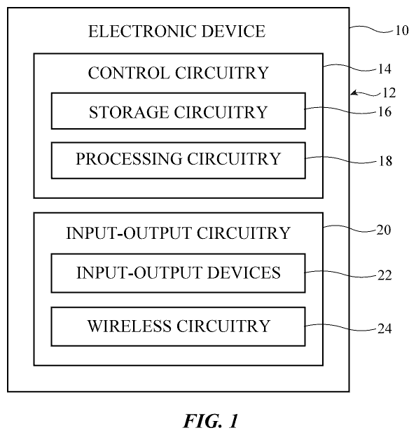

An electronic device such as device 10 of FIG. 1 may be provided with wireless circuitry having a hybrid coupler as described below. The hybrid coupler may be a quadrature 3 dB hybrid coupler having four ports: port 1, port 2, port 3, and port 4. The quadrature 3 dB hybrid coupling can be configured to split a signal arriving at port 1 evenly between port 2 and port 3 while providing a 90 degree phase shift between port 2 and port 3, with no signal being coupled to port 4 (isolation port).

In accordance with some embodiments, a hybrid coupler can include first and second conductive paths formed in at least three different (consecutive) metal routing layers. The first conductive path of the hybrid coupler can include an outer winding in a first (top) metal routing layer, an inner winding in a second (middle) metal routing layer, and an outer winding in a third (bottom) metal routing layer. The second conductive path of the hybrid coupler can include an inner winding in the first metal routing layer, an outer winding in the second metal routing layer, and an inner winding in the third metal routing layer. Arranged in this way, the first and second conductive paths can exhibit interdigitated broadside and edge coupling to provide a coupling coefficient C of greater than 0.707. Having such elevated coupling allows the length of each of the first and second conductive paths to be less than λ/4 without the use of any additional capacitors. Achieving increased coupling using relatively wide conductive paths in a hybrid coupler in this way provides enhanced immunity to process variation within a compact footprint.

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, parts or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more microprocessors, microcontrollers, digital signal processors, host processors, baseband processor integrated circuits, application specific integrated circuits, central processing units (CPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 5G protocols, etc.), Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support or perform radio-frequency signal transmission and/or reception for device 10. Wireless circuitry 24 may be used for wireless communications. Wireless communications performed by wireless circuitry 24 may include or involve wireless data communications (e.g., where wireless data is carried by radio-frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals.

Wireless circuitry 24 is thus sometimes also referred to herein as wireless communications circuitry 24, wireless communication circuitry 24, communications circuitry 24, or simply as circuitry 24. Wireless circuitry 24 may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s). Some or all of the components of wireless circuitry 24 may be disposed on, mounted to, communicatively coupled to, and/or integrated within the same substrate (e.g., a printed circuit board, semiconductor substrate, chip, integrated circuit (IC), IC packages, etc.) or may be distributed between two or more substrates (e.g., printed circuit boards, semiconductor substrates, chips, ICs, IC packages, etc.).

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, etc.), cellular sidebands, 6G bands between 100-1000 GHz (e.g., sub-THz, THz, or THF bands), etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

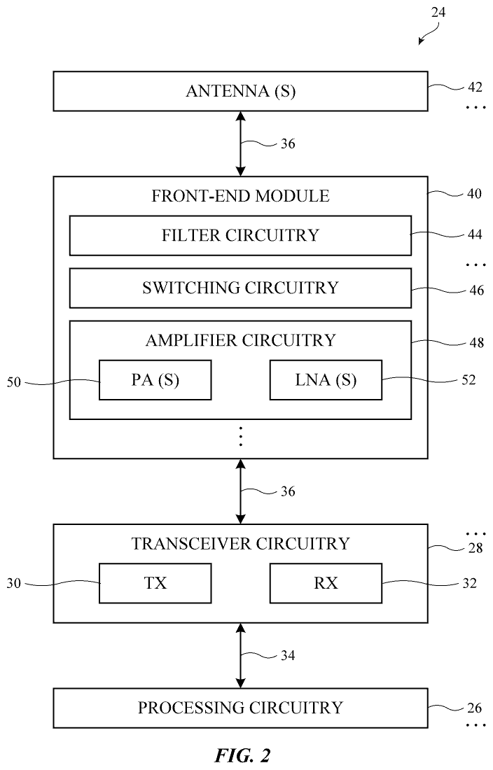

FIG. 2 is a diagram showing illustrative components within wireless circuitry 24. As shown in FIG. 2, wireless circuitry 24 may include processing circuitry such as processing circuitry 26, radio-frequency (RF) transceiver circuitry such as radio-frequency transceiver 28, radio-frequency front-end circuitry such as radio-frequency front-end module (FEM) 40, and antenna(s) 42. Processing circuitry 26 may include one or more baseband processor, application processor, general purpose processor, microprocessor, microcontroller, digital signal processor, host processor, application specific signal processing hardware, and/or other type of processor. Processing circuitry 26 may be coupled to transceiver 28 over path 34. Transceiver 28 may be coupled to antenna 42 via radio-frequency transmission line path 36. Radio-frequency front-end module 40 may be disposed on radio-frequency transmission line path 36 between transceiver 28 and antenna 42.

In the example of FIG. 2, wireless circuitry 24 is illustrated as including only a single processing unit 26, a single transceiver 28, a single front-end module 40, and a single antenna 42 for the sake of clarity. In general, wireless circuitry 24 may include any desired number of processing units 26, any desired number of transceivers 28, any desired number of front-end modules 40, and any desired number of antennas 42. Each processing unit 26 may be coupled to one or more transceiver 28 over respective paths 34. Each transceiver 28 may include a transmitter circuit 30 configured to output uplink signals to antenna 42, may include a receiver circuit 32 configured to receive downlink signals from antenna 42, and may be coupled to one or more antennas 42 over respective radio-frequency transmission line paths 36. Each radio-frequency transmission line path 36 may have a respective front-end module 40 disposed thereon. If desired, two or more front-end modules 40 may be disposed on the same radio-frequency transmission line path 36. If desired, one or more of the radio-frequency transmission line paths 36 in wireless circuitry 24 may be implemented without any front-end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is merely illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards.

In performing wireless transmission, processing circuitry 26 may provide transmit signals (e.g., digital or baseband signals) to transceiver 28 over path 34. Transceiver 28 may further include circuitry for converting the transmit (baseband) signals received from processing circuitry 26 into corresponding radio-frequency signals. For example, transceiver circuitry 28 may include mixer circuitry for up-converting (or modulating) the transmit (baseband) signals to radio frequencies prior to transmission over antenna 42. The example of FIG. 2 in which processing circuitry 26 communicates with transceiver 28 is merely illustrative. In general, transceiver 28 may communicate with a baseband processor, an application processor, general purpose processor, a microcontroller, a microprocessor, or one or more processors within circuitry 18. Transceiver circuitry 28 may also include digital-to-analog converter (DAC) and/or analog-to-digital converter (ADC) circuitry for converting signals between digital and analog domains. Transceiver 28 may use transmitter (TX) 30 to transmit the radio-frequency signals over antenna 42 via radio-frequency transmission line path 36 and front-end module 40. Antenna 42 may transmit the radio-frequency signals to external wireless equipment by radiating the radio-frequency signals into free space.

In performing wireless reception, antenna 42 may receive radio-frequency signals from the external wireless equipment. The received radio-frequency signals may be conveyed to transceiver 28 via radio-frequency transmission line path 36 and front-end module 40. Transceiver 28 may include circuitry such as receiver (RX) 32 for receiving signals from front-end module 40 and for converting the received radio-frequency signals into corresponding baseband signals. For example, transceiver 28 may include mixer circuitry for down-converting (or demodulating) the received radio-frequency signals to baseband frequencies prior to conveying the received signals to processor 26 over path 34.

Front-end module (FEM) 40 may include radio-frequency front-end circuitry that operates on the radio-frequency signals conveyed (transmitted and/or received) over radio-frequency transmission line path 36. FEM 40 may, for example, include front-end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifier circuits 50 and/or one or more low-noise amplifier circuits 52), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front-end module components may be mounted to a common (shared) substrate such as a rigid printed circuit board substrate or flexible printed circuit substrate. If desired, the various front-end module components may also be integrated into a single integrated circuit chip. If desired, amplifier circuitry 48 and/or other components in front-end 40 such as filter circuitry 44 may also be implemented as part of transceiver circuitry 28.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Transceiver 28 may be separate from front-end module 40. For example, transceiver 28 may be formed on another substrate such as the main logic board of device 10, a rigid printed circuit board, or flexible printed circuit that is not a part of front-end module 40. While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processor 26 and/or portions of transceiver 28 (e.g., a host processor on transceiver 28) may form a part of control circuitry 14. Control circuitry 14 (e.g., portions of control circuitry 14 formed on processor 26, portions of control circuitry 14 formed on transceiver 28, and/or portions of control circuitry 14 that are separate from wireless circuitry 24) may provide control signals (e.g., over one or more control paths in device 10) that control the operation of front-end module 40.

Transceiver circuitry 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

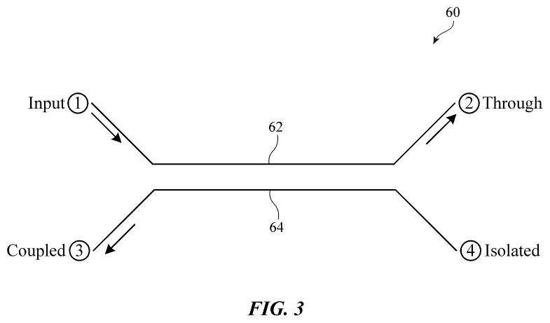

In accordance with an embodiment, wireless circuitry 24 can be provided with a hybrid coupling circuit such as hybrid coupler 60. As an example, hybrid coupler 60 can be included as part of radio-frequency front-end module 40. Wireless circuitry 24 can generally include one or more hybrid couplers 60. As another example, one or more hybrid coupler(s) 60 can be included as part of transceiver circuitry 28 or other wireless component within device 10 (see FIG. 1). As shown in FIG. 3, hybrid coupler 60 may be a passive device with at least four ports configured to combine or split radio-frequency (RF) signals. For example, hybrid coupler 60 can be configured to split one or more input signals into two corresponding output signals that are 90 degrees out-of-phase with one another. Such type of hybrid coupler 60 is sometimes referred to and defined herein as a 90 degree hybrid coupler or a “quadrature” hybrid coupler.

In the embodiment of FIG. 3, hybrid coupler 60 may have a first (input) port, a second (through) port, a third (coupled) port, and a fourth (isolated) port. The first port (labeled as “1”) can be configured to receive a radio-frequency input signal and is thus sometimes referred to as an “input” port. The second port (labeled as “2”) can be a corresponding output port where the input signal egresses with minimal loss, typically maintaining the same phase as the input signal. In other words, the second port can be configured to output a signal that is in phase with the input signal. The second port is thus sometimes referred to as a “through” port. The third port (labeled as “3”) can be configured as a port where a portion of the input signal egresses with a 90 degree phase shift, in the case of quadrature hybrid coupler 60. In other words, the third port can be configured to output a signal that is 90 degrees out of phase with the input signal. The third port is thus sometimes referred to as the “coupled” port. The fourth port (labeled as “4”) can be configured as a port that is ideally isolated from the input signal and is thus sometimes referred to as the “isolated” or “isolation” port (e.g., the fourth port may be isolated from at least the first port).

Still referring to FIG. 3, a first conductive line such as conductive line 62 can have a first distal end coupled to the first (1) port and a second distal end coupled to the second (2) port, whereas a second conductive line such as conductive line 64 can have a first distal end coupled to the third (3) port and a second distal end coupled to the fourth (4) port. First conductive line 62 may be magnetically coupled, via capacitive coupling and inductive coupling, to second conductive line 64. Such type of hybrid coupler 60 having a pair of coupled lines 62 and 64 is sometimes referred to as a “coupled line” hybrid coupler.

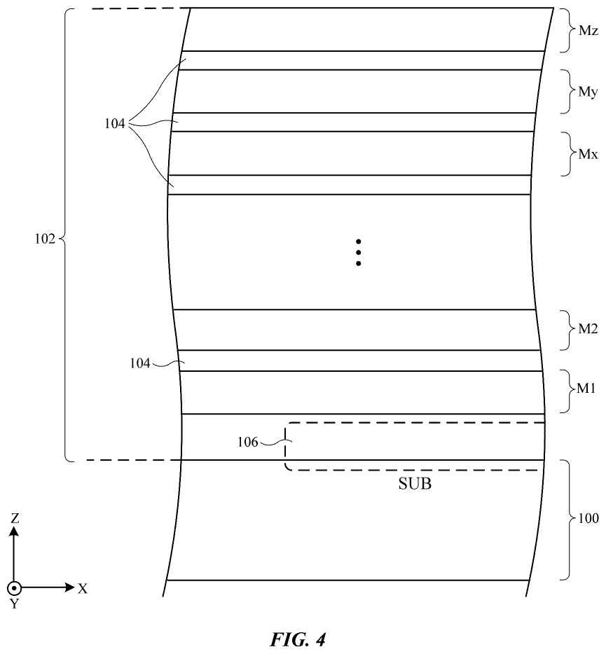

Hybrid coupler 60 of the type described in connection with FIG. 3 can be formed in an interconnect stack of an integrated circuit (IC) die. FIG. 4 is a side view of an illustrative interconnect stack 102 in which a hybrid coupler can be formed in accordance with some embodiments. As shown in FIG. 4, an interconnect stack such as interconnect stack 102 can be formed on a semiconductor substrate 100 (e.g., a p-doped silicon substrate). Interconnect stack 102 may include alternating routing layers and via layers. Each routing layer can include conductive (metal) routing paths such as metal routing structures formed in a layer of dielectric material and is thus sometimes referred to as a conductive (metal) routing layer.

In the arrangement of FIG. 4, the bottommost metal routing layer of interconnect stack 102 is sometimes referred to as a first metal routing layer M1, a metal routing layer immediately above the first metal routing layer M1 can be referred to as a second metal routing layer M2, and so on. At the other end, the uppermost (topmost) metal routing layer of interconnect stack 102 can be referred to herein as metal routing layer Mz, a metal routing layer immediately below the topmost metal routing layer Mz can be referred to as metal routing layer My, a metal routing layer immediately below metal routing layer My can be referred to as a metal routing layer Mx, and so on. Relative to metal routing line that can be formed in the lower levels (e.g., the M1 or M2 metal routing layers) of interconnect stack 102, metal routing lines that are formed in the upper levels (e.g., the Mz, My, and/or Mx metal routing layers) of interconnect stack 102 tend to be wider and/or thicker and thus exhibit lower resistance.

Successive metal routing layers in the interconnect stack 102 can be separated by a via layer 104. Each via layer 104 can include conductive (metal) vias such as metal via structures formed in a layer of dielectric material and is thus sometimes referred to herein as a conductive (metal) via layer. Interconnect stack 102 arranged in this way is therefore sometimes referred to as a dielectric stack (e.g., an interconnect stack having conductive routing paths formed within dielectric material such as silicon dioxide). The conductive routing structures in the various routing layers and the conductive via structures of the dielectric stack can be formed using copper, aluminum, tungsten, titanium, gold, silver, nickel, a metal alloy, a combination of metals, and/or other types of conductive material. The metal routing structures and the metal via structures can collectively form an electrical network for interconnecting together various components within the IC die. In general, one or more transistor structures can be formed in region 106 near the interface between substrate 100 and interconnect stack 102.

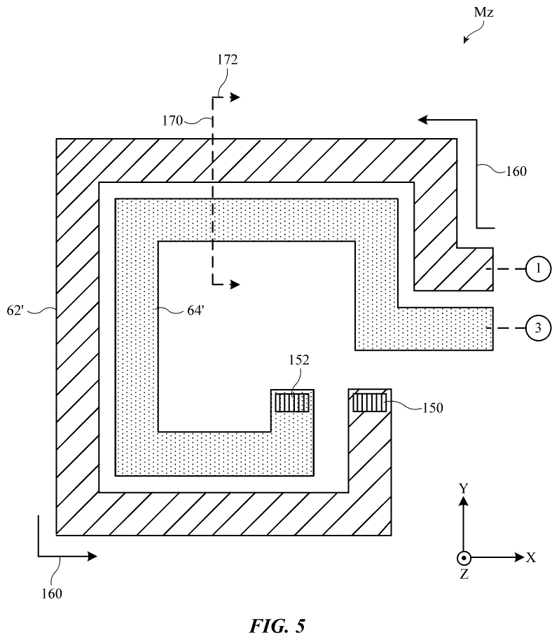

In accordance with an embodiment, hybrid coupler 60 can be formed in the upper levels of the interconnect stack 102. FIGS. 5-7 illustrate an example where hybrid coupler 60 is formed in the three uppermost consecutive metal routing layers Mz, My, and Mx of the interconnect stack 102. For example, metal routing layer Mz might include metal routing structures formed from a first metal such as aluminum, whereas metal routing layers My and Mx may include metal routing structures formed from a second metal such as copper. Metal routing structures in the upper metal routing layers of interconnect stack 102 tend to be longer and wider routing paths, which can be technically advantageous and beneficial to provide enhanced immunity to process variations. This arrangement is exemplary. In other embodiments, hybrid coupler 60 might be formed in other metal routing layers of interconnect stack 102.

FIG. 5 is a top (layout) view showing a first portion of hybrid coupler 60 disposed in metal routing layer Mz of interconnect stack 102. As shown in FIG. 5, a first segment 62′ of the first conductive line 62 and a first segment 64′ of the second conductive line 64 may be formed in the Mz metal routing layer. The first segment 62′ may have a first distal end coupled to the first (1) port and a second distal end coupled to metal via 150. Assuming a current or other input signal is fed into the first port in the direction of arrow 160, the signal will flow counterclockwise in the orientation shown in FIG. 5. The first segment 64′ may have a first distal end coupled to the third (3) port and a second distal end coupled to metal via 152. The first segment 62′ may at least partially surround or wrapped around the first segment 64′ (e.g., first segment 62′ may completely surround segment 64′ from three sides and at least partially surround segment 64′ on the fourth side). In the example of FIG. 5, segments 62′ and 64′ are wound in a rectangular or squarish shape. If desired, segments 62′ and 64′ can alternatively be wound to exhibit a hexagonal shape, an octagonal shape, a circular shape, or other suitable coil-like arrangement. Segment 62′ surrounding segment 64′ can be referred to as the “outer” winding, whereas segment 64′ that is being surrounded can be referred to as the “inner” winding.

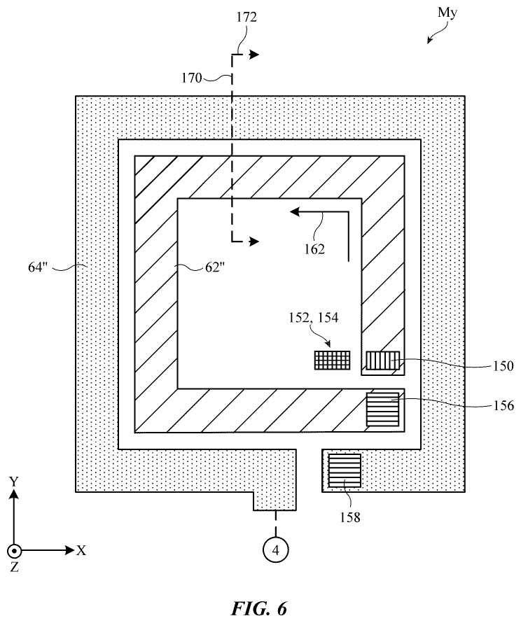

FIG. 6 is a top (layout) view showing a second portion of hybrid coupler 60 disposed in metal routing layer My of interconnect stack 102. As shown in FIG. 6, a second segment 62″ of the first conductive line 62 and a second segment 64″ of the second conductive line 64 may be formed in the My metal routing layer. The second segment 62″ may have a first distal end coupled to metal via 150 and a second distal end coupled to metal via 156. Arranged in this way, metal via 150 connects the first distal end of segment 62″ in the My metal layer to the second distal end of segment 62′ in the Mz metal layer. Assuming the current or other input signal is fed into the first port and continues down into segment 62″, the signal will continue to flow counterclockwise in the direction of arrow 162 in the orientation shown in FIG. 6.

The second segment 64″ may have a first distal end coupled to metal via 158 and a second distal end coupled to the fourth (4) port. The second segment 64″ may completely surround or wrap around the second segment 62″ (e.g., segment 64″ may surround segment 62″ from all four sides). In the example of FIG. 6, segments 62″ and 64″ are wound in a rectangular or squarish shape. If desired, segments 62″ and 64″ can alternatively be wound to exhibit a hexagonal shape, an octagonal shape, a circular shape, or other suitable coil-like arrangement to match the footprint of segments 62′ and 64′ in the Mz metal layer. Moreover, metal vias 152 and 154 can be formed in a central region within the inner perimeter of segment 62″. Metal via 152 may connect to the second distal end of segment 64′ in the Mz metal layer. Segment 64″ surrounding segment 62″ can be referred to as the “outer” winding, whereas segment 62″ that is being surrounded can be referred to as the “inner” winding.

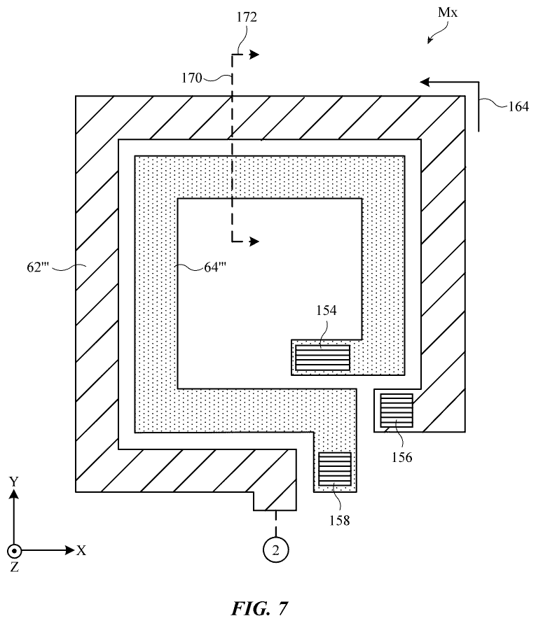

FIG. 7 is a top (layout) view showing a third portion of hybrid coupler 60 disposed in metal routing layer Mx of interconnect stack 102. As shown in FIG. 7, a third segment 62′″ of the first conductive line 62 and a third segment 64″ of the second conductive line 64 may be formed in the Mx metal routing layer. The third segment 62′″ may have a first distal end coupled to metal via 156 and a second distal end coupled to the second (2) port. Arranged in this way, metal via 156 connects the first distal end of segment 62′″ in the Mx metal layer to the second distal end of segment 62″ in the My metal layer. Assuming the current or other input signal is fed into the first port and continues down into segment 62′″, the signal will continue to flow counterclockwise in the direction of arrow 164 in the orientation shown in FIG. 7.

The third segment 64′″ may have a first distal end coupled to metal via 154 and a second distal end coupled to the metal via 158. Arranged in this way, metal via 154 connects the first distal end of segment 64′″ in the Mx metal layer directly up, through intervening metal via 152, to the second distal end of segment 64′ in the Mz metal layer. In other words, segment 64′ in the Mz metal layer can be directly connected to segment 64′″ in the Mx metal layer through two consecutive vias 152 and 154. Moreover, metal via 158 can connect the second distal end of segment 64′″ to the first distal end of segment 64″ in the My metal layer.

The third segment 62′″ may at least partially surround or wrap around the third segment 64′″ (e.g., segment 62′″ may completely surround segment 64′″ from three sides and may only partially surround segment 64′″ on the fourth side). In the example of FIG. 7, segments 62′″ and 64′″ are wound in a rectangular or squarish shape. If desired, segments 62′″ and 64′″ can alternatively be wound to exhibit a hexagonal shape, an octagonal shape, a circular shape, or other suitable coil-like arrangement to match the footprint of segments 62′ and 64′ in the My/Mz metal layers. Segment 62′″ surrounding segment 64′″ can be referred to as the “outer” winding, whereas segment 64′″ that is being surrounded can be referred to as the “inner” winding. Arranged in this way, hybrid coupler 60 can be formed in only three metal routing layers of the interconnect stack 102 (e.g., formed in three consecutive or successive metal routing layers of the dielectric stack).

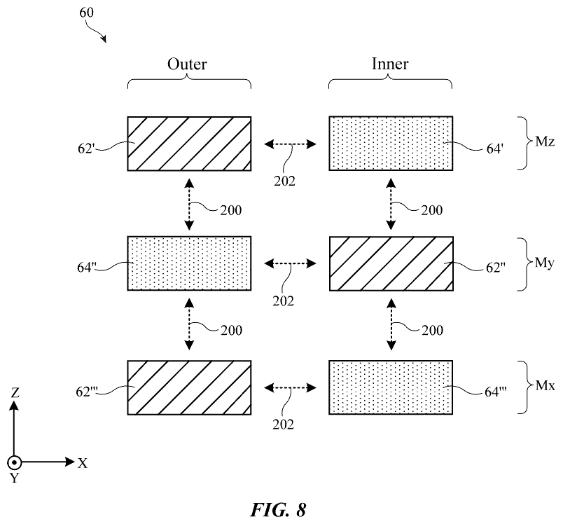

FIG. 8 is a cross-sectional side view of a portion of hybrid coupler 60 that is cut along line 170 and viewed in the direction of arrow 172 (see dotted line 170 and arrow 172 in FIGS. 5, 6, and 7). As shown in FIG. 8, outer segment 62′ may be arranged laterally with respect to inner segment 64′ in the Mz metal routing layer. In the My metal routing layer, outer segment 64″ may be arranged laterally with respect to inner segment 62″. Outer segment 64″ may be disposed directly under segment outer 62′, whereas inner segment 62″ may be disposed directly under inner segment 64′. In the Mx metal routing layer, outer segment 62′″ may be arranged laterally with respect to inner segment 64′″. Outer segment 62′″ may be disposed directly under segment outer 64″, whereas inner segment 64′″ may be disposed directly under inner segment 62″. In other words, outer segment 64″ can be disposed directly in between segments 62′ and 62′″, whereas inner segment 62″ can be disposed directly in between segments 64′ and 64′″.

Arranged in this way, all neighboring conductive segments belong to different portions of the two conductive lines 62 and 64. As an example, the two segments 62′ and 62′″ of the first conductive line 62 are separated by segment 64″ of the second conductive line 64. As another example, the two segments 64′ and 64′″ of the second conductive line 64 are separated by segment 62″ of the first conductive line 62. This vertical alternation or interdigitating of conductive lines can be technically advantageous to provide maximum broadside coupling between lines 62 and 64, as illustrated by arrows 200. Here, “broadside” coupling can refer to capacitive and inductive coupling in the vertical (Z) direction. In addition to the broadside or lateral coupling, the outer and inner segments in each metal routing layer can further provide edge coupling between conductive lines 62 and 64, as illustrated by arrows 202. Here, “edge” coupling can refer to capacitive and inductive coupling in the horizontal (X) direction.

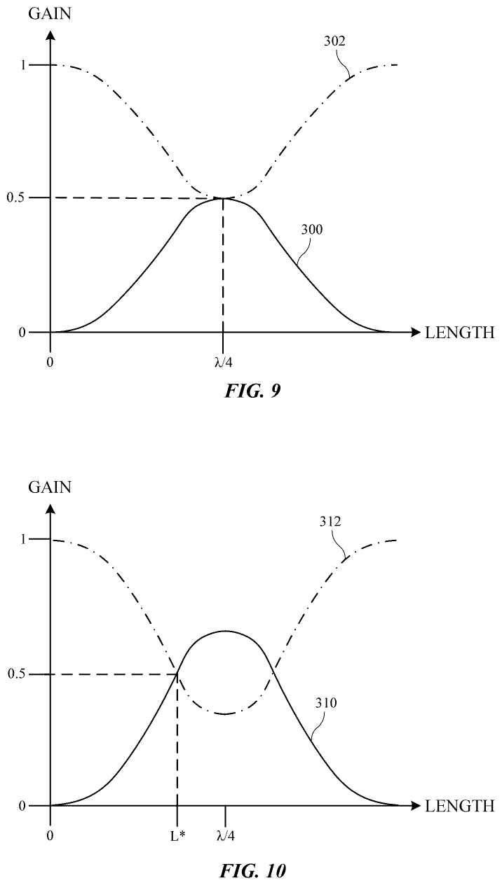

FIG. 9 is plot showing signal gain as a function of wavelength for a conventional quadrature hybrid coupler having coupled lines with lengths equal to a quarter wavelength (λ/4), where λ represents the wavelength of the radio-frequency input signal being received at the input port of the conventional quadrature hybrid coupler. In FIG. 9, curve 300 may represent the amount of power being transmitted from port 1 to port 3 of the hybrid coupler, sometimes referred to as the cross-port transmission gain or S₃₁ parameter. Curve 302 may represent the amount of power being transmitted from port 1 to port 2 of the hybrid coupler, sometimes referred to as the forward transmission gain or S₂₁ parameter. Here, curves 300 and 302 coincide at a path length of λ/4 to produce a maximum matched gain of 0.5 for both ports 2 and 3. Such transmission profile can be achieved when the length of each coupled line in the hybrid coupler is equal to λ/4 and when the coupling coefficient between the pair of coupled lines in the hybrid coupler is equal to about 0.707 or √(2)/2 (i.e., half of square root of two).

In accordance with an embodiment, FIG. 10 is plot showing signal gain as a function of wavelength for quadrature hybrid coupler 60 of the type described in connection with at least FIGS. 3-8. In FIG. 10, curve 310 may represent the amount of power being transmitted from port 1 to port 3 of hybrid coupler 60, sometimes referred to as the cross-port transmission gain or S₃₁ parameter. Curve 312 may represent the amount of power being transmitted from port 1 to port 2 of hybrid coupler 60, sometimes referred to as the forward transmission gain or S₂₁ parameter. Here, curves 310 and 312 coincide at a path length of L* (as an example) to produce a maximum matched gain of 0.5 for both ports 2 and 3.

Such transmission profile can be achieved when the length L* of conductive line 62 and the length of conductive line 64 in hybrid coupler 60 is to a value that is less than λ/4, where λ represents the wavelength of the radio-frequency input signal being received at port 1 of hybrid coupler 60. As examples, length L* can be equal to λ/8, λ/16, λ/32, λ/3, some fraction of 2, or other length less than λ/4. Such reduction in the required length of each conductive line in the pair of coupled lines in hybrid coupler 60 can be a result of the phenomenon that the coupling coefficient between lines 62 and 64, as arranged in the way described in connection with FIGS. 5-8, will be greater than 0.707 or greater than √(2)/2. For example, the coupling coefficient between lines 62 and 64 can be at least 2% greater than 0.707, at least 5% greater than 0.707, 5-10% greater than 0.707, 10-20% greater than 0.707, 20-30% greater than 0.707, 30-40% greater than 0.707, 40-50% greater than 0.707, 50-100% greater than 0.707, or more than 100% greater than 0.707. Such boost in the coupling coefficient between lines 62 and 64 further obviates the need for additional capacitors that would otherwise be needed in a conventional hybrid coupler to achieve elevated levels of coupling.

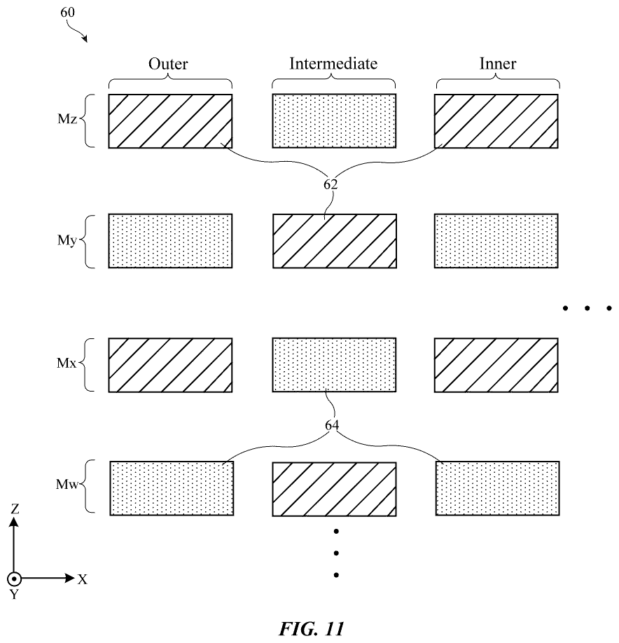

The cross section of FIG. 8 showing how hybrid coupler 60 includes two conductive lines 62 and 64 forming an outer winding and an inner winding in each of three consecutive metal routing layers Mz, My, and Mx is exemplary. FIG. 11 shows another embodiment of a quadrature hybrid coupler 60 that includes two conductive lines 62 and 64 forming at least an outer winding, an inner winding, and an additional intermediate winding interposed between the outer winding and the inner winding across four consecutive metal routing layers Mz, My, Mx, and Mw. As shown in FIG. 11, the segments of conductive line 62 and the segments of conductive line 64 are alternating (interdigitated) in the vertical (Z) direction to provide maximum broadside coupling between the pair of coupled lines 62 and 64 and are also alternating (interdigitated) in the horizontal (X) direction to provide maximum edge coupling between the pair of coupled lines 62 and 64. If desired, each metal routing layer can include four or more interdigitated windings. If desired, conductive routing lines 62 and 64 can be formed across four or more metal routing layers of the interconnect stack. If desired, other ways of configuring hybrid coupler 60 in the interconnect stack can be employed.

The foregoing is merely illustrative and various modifications can be made to the described embodiments. The foregoing embodiments may be implemented individually or in any combination.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users,

What is claimed is:

1. A quadrature hybrid coupling circuit comprising:
a first port configured to receive an input signal;
a second port configured to output a corresponding signal that is in phase with the input signal;
a third port configured to output a corresponding signal that is 90 degrees out of phase with the input signal;
a fourth port that is isolated from at least the first port;
a first segment of a first conductive line, wherein the first segment of the first conductive line has a first distal end coupled to the first port; and
a first segment of a second conductive line magnetically coupled to the first conductive line, wherein the first segment of the second conductive line has a first distal end coupled to the third port, and wherein the first segment of the first conductive line and the first segment of the second conductive line are disposed in a first conductive routing layer of an interconnect stack.

2. The quadrature hybrid coupling circuit of claim 1, wherein the first segment of the first conductive line surrounds the first segment of the second conductive line from at least three sides.

3. The quadrature hybrid coupling circuit of claim 2, wherein the first segment of the first conductive line at least partially surrounds the first segment of the second conductive line on a fourth side.

4. The quadrature hybrid coupling circuit of claim 1, further comprising:
a second segment of the first conductive line, wherein the second segment of the first conductive line has a first distal end coupled to a second distal end of the first segment of the first conductive line through a first conductive via; and
a second segment of the second conductive line, wherein the second segment of the second conductive line has a first distal end and a second distal end that is coupled to the fourth port, and wherein the second segment of the first conductive line and the second segment of the second conductive line are disposed in a second conductive routing layer of the interconnect stack.

5. The quadrature hybrid coupling circuit of claim 4, wherein the second segment of the second conductive line surrounds the second segment of the second conductive line from four sides.

6. The quadrature hybrid coupling circuit of claim 4, further comprising:
a third segment of the first conductive line, wherein the third segment of the first conductive line has a first distal end coupled to a second distal end of the second segment of the first conductive line through a second conductive via and has a second distal end coupled to the second port; and
a third segment of the second conductive line, wherein the third segment of the second conductive line has a first distal end coupled to the second distal end of the first segment of the second conductive line through third and fourth conductive vias and has a second distal end coupled to the first distal end of the second segment of the second conductive line through a fifth conductive via, and wherein the third segment of the first conductive line and the third segment of the second conductive line are disposed in a third conductive routing layer of the interconnect stack.

7. The quadrature hybrid coupling circuit of claim 6, wherein the third segment of the second conductive line surrounds the third segment of the second conductive line from at least three sides.

8. The quadrature hybrid coupling circuit of claim 6, wherein the first conductive routing layer, the second conductive routing layer, and the third conductive routing layer comprise three consecutive metal routing layers in the interconnect stack.

9. The quadrature hybrid coupling circuit of claim 6, wherein:
a current flowing into the first port flows in a first direction through the first segment of the first conductive line in the first conductive routing layer, in the first direction through the second segment of the first conductive line in the second conductive routing layer, and in the first direction through the third segment of the first conductive line in the third conductive routing layer.

10. The quadrature hybrid coupling circuit of claim 1, wherein the first conductive line and the second conductive line include rectangular windings only formed in the first, second, and third conductive routing layers of the interconnect stack.

11. A quadrature hybrid coupler comprising:
a first conductive line coupled between a first port and a second port; and
a second conductive line magnetically coupled to the first conductive line and coupled between a third port and a fourth port, wherein:
a first segment of the second conductive line is disposed in a first conductive routing layer of an interconnect stack; and
a first segment of the first conductive line is disposed in the first conductive routing layer and surrounds the first segment of the second conductive line from at least three sides.

12. The quadrature hybrid coupler of claim 11, wherein:
a second segment of the first conductive line is disposed in a second conductive routing layer of the interconnect stack; and
a second segment of the second conductive line is disposed in the second conductive routing layer and surrounds the second segment of the first conductive line from four sides.

13. The quadrature hybrid coupler of claim 11, wherein:
a third segment of the second conductive line is disposed in a third conductive routing layer of the interconnect stack; and
a third segment of the first conductive line is disposed in the third conductive routing layer and surrounds the third segment of the second conductive line from at least three sides.

14. The quadrature hybrid coupler of claim 13, wherein:
the first port is configured to receive a radio-frequency signal having a wavelength; and
the first and second conductive lines each have a length that is less than a quarter of the wavelength of the radio-frequency signal.

15. The quadrature hybrid coupler of claim 14, wherein the first conductive line is magnetically coupled to the second conductive line via a coupling coefficient greater than half of square root of two.

16. A hybrid coupler comprising:
a first conductive line coupled between a first port and a second port; and
a second conductive line magnetically coupled to the first conductive line and coupled between a third port and a fourth port, wherein the first conductive line is magnetically coupled to the second conductive line via a coupling coefficient greater than half of square root of two.

17. The hybrid coupler of claim 16, wherein:
the first port is configured to receive a radio-frequency signal having a wavelength; and
the first and second conductive lines each have a length that is less than a quarter of the wavelength of the radio-frequency signal.

18. The hybrid coupler of claim 16, wherein:
a first segment of the second conductive line is disposed in a first conductive routing layer of an interconnect stack; and
a first segment of the first conductive line is disposed in the first conductive routing layer and surrounds the first segment of the second conductive line from at least three sides.

19. The hybrid coupler of claim 18, wherein:
a second segment of the first conductive line is disposed in a second conductive routing layer of the interconnect stack; and
a second segment of the second conductive line is disposed in the second conductive routing layer and surrounds the second segment of the first conductive line from four sides.

20. The quadrature hybrid coupler of claim 19, wherein:
a third segment of the second conductive line is disposed in a third conductive routing layer of the interconnect stack;
a third segment of the first conductive line is disposed in the third conductive routing layer and surrounds the third segment of the second conductive line from at least three sides; and
the first conductive line and the second conductive line include rectangular windings only formed in the first, second, and third conductive routing layers of the interconnect stack.
